(19) United States
(12) Patent Application Publication
(10) Pub. No.: US 2005/0059457 A1
(43) Pub. Date: Mar. 17, 2005

(54) Apparatus and method for presenting media content on a gaming device

(76) Inventors: Wayne H. Rothschild, Northbrook, IL (US); Shridhar P. Joshi, Skokie, IL (US); Larry Pacey, Northbrook, IL (US)

Correspondence Address: Schwegman, Lundberg, Woessner & Kluth, P.A., P.O. Box 2938, Minneapolis, MN, 55402, US

(21) Appl. No.: 10/661,382

(22) Filed: Sep. 12, 2003

(51) Int. Cl. A63F 13/00

(52) U.S. Cl. 463/16

(57) ABSTRACT

An apparatus and method for presenting media content on a gaming device are described herein. In one embodiment the apparatus includes a gaming control unit to transmit media presentation requests. The apparatus also includes a set of one or more media control units to receive the media presentation requests from the gaming control unit and present primary media and secondary media, wherein the secondary media is presented when the a game is in a bonus state, and wherein each media control unit of the set includes an adapted Sony PlayStation 2.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### FIELD

This invention relates generally to the field of gaming machines and more specifically to presenting video content on gaming machines.

### BACKGROUND

As gaming devices (e.g., slot machines) continue to evolve, they continue to provide new and entertaining ways for presenting gaming content. Typically, gaming machines present at least two types of media, including primary media and secondary media. Primary media directly indicates various states of a game. For example, primary media includes content for representing the spinning reels of a slot machine. Primary media also includes content for representing the slot machine game results. In contrast, secondary media includes content for representing bonus schemes and other various informational and entertainment content. For example, secondary media can include information about slot machine bonuses, related progressive slot machine games, slot machine tournament information, etc. Additionally, secondary media can include content for entertaining slot machine players during various stages of a game.

Typically, gaming devices include two media presentation systems. A primary media presentation system is used for presenting primary media, while a secondary media presentation system is used for presenting secondary media. Typically, the media presentation systems are custom-designed from various ASICs, processors, and controllers to perform specific media operations. Custom designing and integrating the media presentation systems can be very cumbersome and expensive. One disadvantage of custom designing media presentation systems is that the custom design process increases gaming device design time and cost. Another disadvantage of custom-designed media presentation systems is that maintenance can be more difficult because service technicians may be less familiar with custom-designed media systems.

### SUMMARY

An apparatus and method for presenting media content on a gaming device are described herein. In one embodiment the apparatus includes a gaming control unit to transmit media presentation requests. The apparatus also includes a set of one or more media control units to receive the media presentation requests from the gaming control unit and present primary media and secondary media, wherein the secondary media is presented when the a game is in a bonus state, and wherein each media control unit of the set includes an adapted Sony PlayStation 2.

In one embodiment, the method includes transmitting a first set of one or more media presentation requests to a media control unit, wherein the media control unit is included within a gaming device, and wherein the media control unit includes an adapted video game system. The method also includes receiving, in a gaming control unit, a second set of one or more media presentation acknowledgements from the media control unit, wherein the media presentation acknowledgements indicate that the media control unit has presented certain media samples.

### BRIEF DESCRIPTION OF THE FIGURES

The present invention is illustrated by way of example and not limitation in the Figures of the accompanying drawings, in which like references indicate similar elements and in which:

FIG. 1 is a perspective view of a gaming device, according to exemplary embodiments of the invention;

FIG. 2 is a block diagram illustrating components of a gaming device, according to exemplary embodiments of the invention;

FIG. 3 is a block diagram illustrating components of a gaming control unit, according to exemplary embodiments of the invention;

FIG. 4 is a block diagram illustrating the secondary media control unit including an adapted video game system, according to exemplary embodiments of the invention;

FIG. 5 is a flow diagram illustrating operations for initializing a gaming device, according to exemplary embodiments of the invention;

FIG. 6 is a flow diagram illustrating operations for presenting media during a game, according to exemplary embodiments of the invention;

FIG. 7 is a flow diagram illustrating operations for requesting the presentation of secondary media, according to exemplary embodiments of the invention;

FIG. 8 is a flow diagram illustrating operations for receiving and processing secondary media presentation requests, according to exemplary embodiments of the invention; and

FIG. 9 is a block diagram illustrating communications between a secondary media control unit and a gaming control unit, according to exemplary embodiments of the invention.

FIG. 10 is a block diagram illustrating a gaming device configured to operate in a network environment, according to embodiments of the invention.

### DESCRIPTION OF THE EMBODIMENTS

In the following description, numerous specific details are set forth. However, it is understood that embodiments of the invention may be practiced without these specific details. In other instances, well-known circuits, structures, and techniques have not been shown in detail in order not to obscure the understanding of this description. Note that in this description, references to “one embodiment,” “an alternative embodiment,” or the like mean that the feature being referred to is included in at least one embodiment of the present invention. Further, separate references to “one embodiment” in this description do not necessarily refer to the same embodiment; however, neither are such embodiments mutually exclusive, unless so stated and except as will be readily apparent to those skilled in the art. Thus, the present invention can include any variety of combinations and/or integrations of the embodiments described herein.

Herein, block diagrams illustrate exemplary embodiments of the invention. Also herein, flow diagrams illustrate operations of the exemplary embodiments of the invention. The operations of the flow diagrams will be described with reference to the exemplary embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams.

### Hardware and Operating Environment

This section provides an overview of the exemplary hardware and the operating environment in which embodiments of the invention can be practiced.

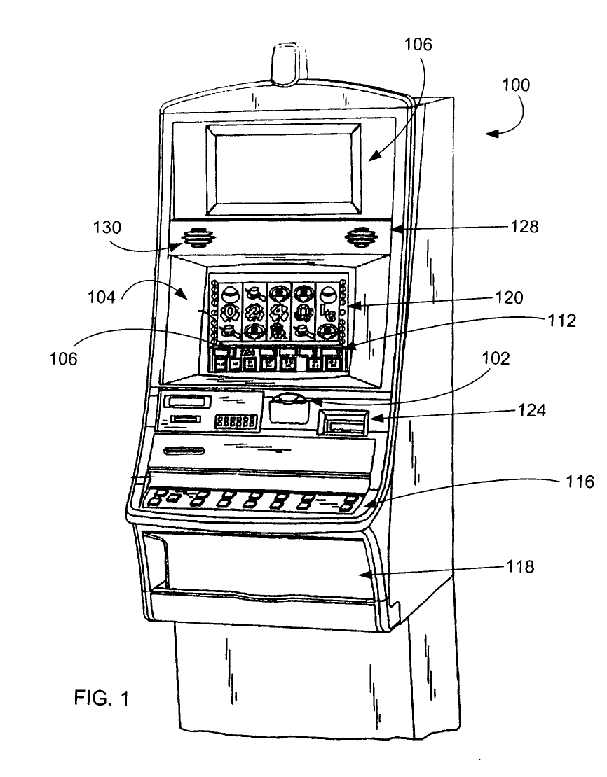

FIG. 1 is a perspective view of a gaming device, according to exemplary embodiments of the invention. As shown in FIG. 1, the gaming device 100 is preferably a slot machine having the controls, displays, and features of a conventional slot machine. The gaming device 100 can be operated while players are standing or seated. Additionally, the gaming device 100 is preferably mounted on a console. However, it should be appreciated that the gaming device 100 can be constructed as a pub-style tabletop game (not shown), which a player can operate while sitting. Furthermore, the gaming device 100 can be constructed with varying cabinet and display designs. The gaming device 100 can incorporate any primary game such as slot, poker, or keno, and additional bonus round games. The symbols and indicia used on and in the gaming device 100 can take mechanical, electrical or video form.

As illustrated in FIG. 1, the gaming device 100 includes a coin slot 102 and bill acceptor 124. Players can place coins in the coin slot 102 and paper money or ticket vouchers in the bill acceptor 124. Other devices can be used for accepting payment. For example, credit/debit card readers/validators can be used for accepting payment. Additionally, the gaming device 100 can perform electronic funds transfers and financial transfers to procure monies from house financial accounts. When a player inserts money in the gaming device 100, a number of credits corresponding to the amount deposited is shown in a credit display 126. After depositing the appropriate amount of money, a player can begin playing the game by pulling the arm 108 or the pushing play button 110. The play button 110 can be any play activator used by the player to start a game or sequence of events in the gaming device 100.

As shown in FIG. 1, the gaming device 100 also includes a bet display 112 and a “bet one” button 114. The player places a bet by pushing the bet one button 114. The player can increase the bet by one credit each time the player pushes the bet one button 114. When the player pushes the bet one button 114, the number of credits shown in the credit display 106 decreases by one, and the number of credits shown in the bet display 112 increases by one.

A player may “cash out” by pressing a cash out button 116. When a player cashes out, the gaming device 100 dispenses a number of coins, corresponding to the number of remaining credits, into the coin tray 118. The gaming device 100 may employ other payout mechanisms such as credit slips, which are redeemable by a cashier, or electronically recordable cards, which track player credits.

The gaming device 100 also includes one or more display devices. The embodiment shown in FIG. 1 includes a primary display unit 104 and a secondary display unit 106. In one embodiment, the primary display unit 104 displays a plurality of reels 120. In one embodiment, the gaming device displays three reels, while an alternative embodiment displays five reels. In one embodiment, the reels are in video form. According to embodiments of the invention, the display units can display any visual representation or exhibition, including moving physical objects (e.g., mechanical reels and wheels), dynamic lighting, and video images. In one embodiment, each reel 120 includes a plurality of symbols such as bells, hearts, fruits, numbers, letters, bars or other images, which correspond to a theme associated with the gaming device 100. Furthermore, as shown in FIG. 1, the gaming device 100 includes a primary sound unit 128 and a secondary sound unit 130. In one embodiment, the primary and secondary sound units include speakers or other suitable sound projection devices.

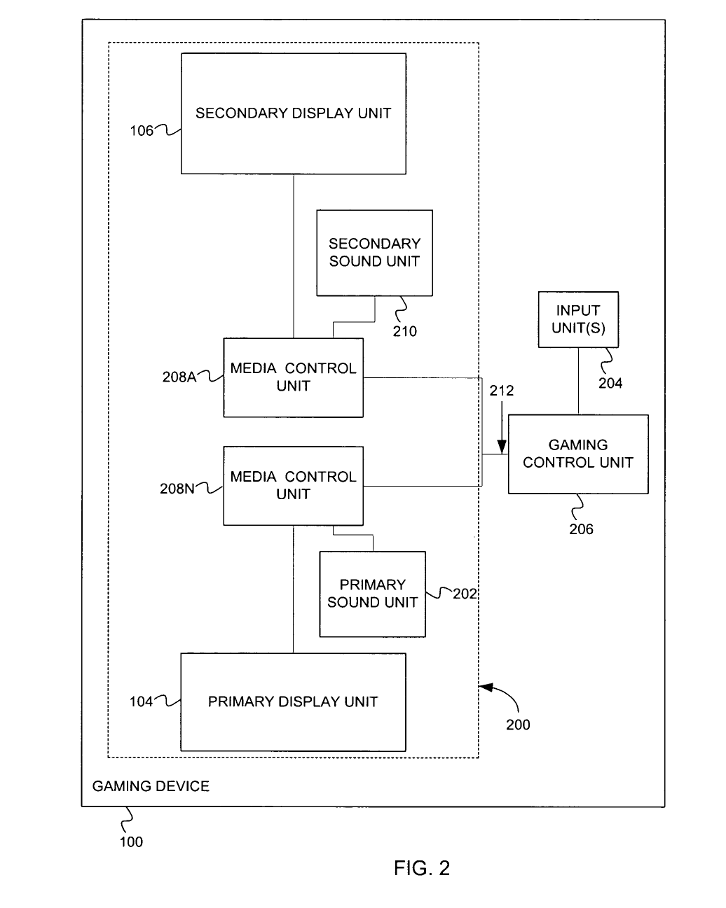

FIG. 2 is a block diagram illustrating components of a gaming device, according to exemplary embodiments of the invention. As shown in FIG. 2, a gaming control unit 206 is connected to an input unit(s) 204 and media control units 208A and 208N. The media control unit 208N is connected to a primary display unit 104 and a primary sound unit 202. The media control unit 208A is connected to a secondary display unit 106 and a secondary sound unit 210. In one embodiment the gaming control unit 206 is connected to the media control units 208A and 208N by a serial communications connection 212, while alternative embodiments call for other suitable communication connections (e.g. a parallel communications connection). In one embodiment, the input unit(s) 204 are connected to the gaming device's buttons 110, 114, and 116 (see FIG. 1). As shown in FIG. 2, the secondary display unit 106, media control units 208A and 208N, secondary sound unit 210, primary display unit 104, and primary sound unit 202 make-up a media system 200.

media control unit 208 media control unit 208 media control unit 208 media control unit 208 media control unit 208

According to embodiments of the invention, the primary sound unit 202 and secondary sound unit 210 can be speakers or other suitable sound projection devices. In one embodiment the primary display unit 104 and secondary display unit 106 can be liquid crystal displays (LCDs), cathode ray tubes (CRTs), projection displays, or other suitable display devices.

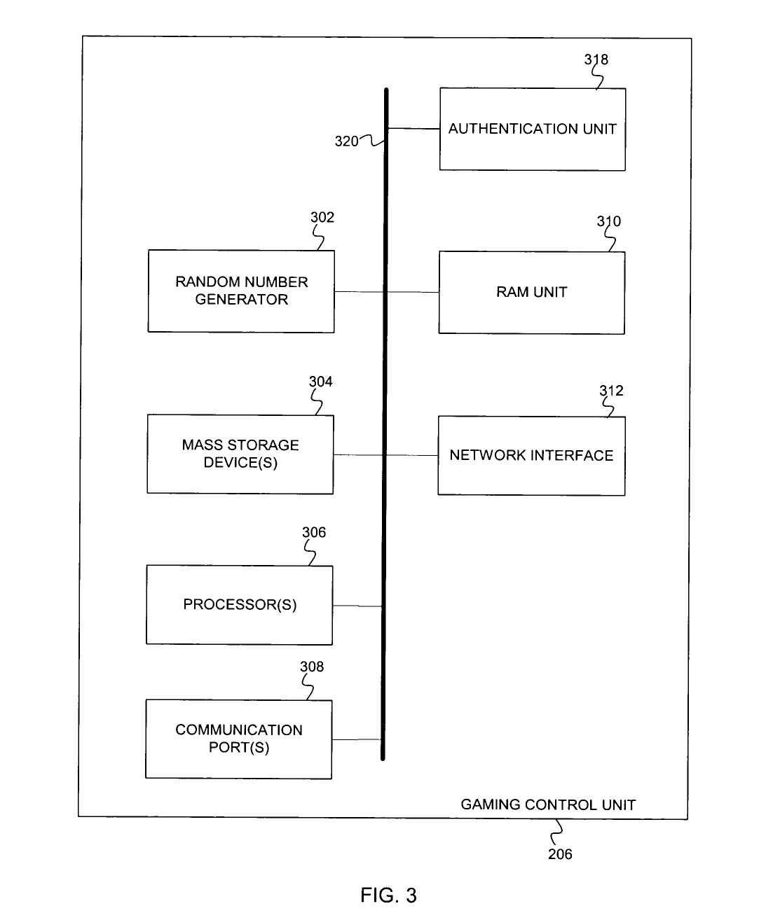

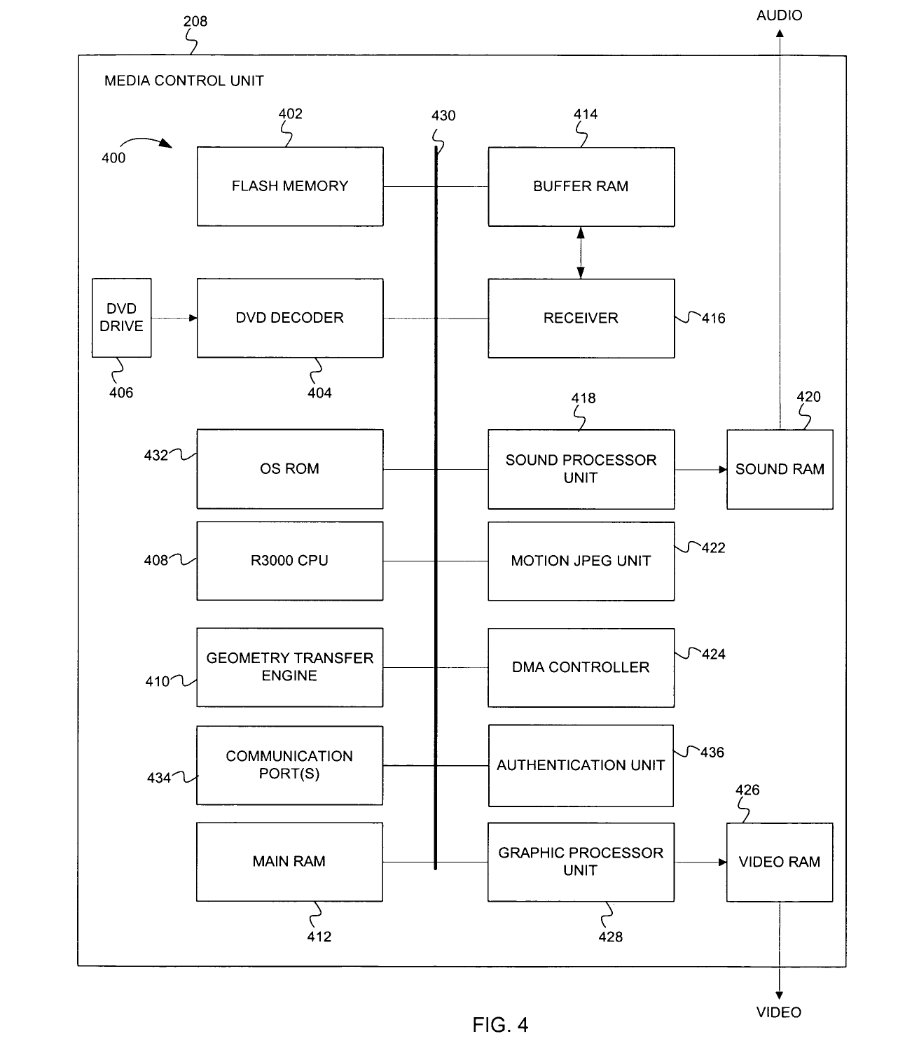

While the discussion of FIGS. 1 and 2 above describes the components and connections that make-up the gaming device 100, FIGS. 3 and 4 reveal subsystems within the gaming device 100. In particular, FIG. 3 describes components within the gaming control unit 206 and FIG. 4 describes components within the media control units.

FIG. 3 is a block diagram illustrating components of a gaming control unit, according to exemplary embodiments of the invention. As shown in FIG. 3, the gaming control unit 206 includes an authentication unit 318, random-access memory (RAM) unit 310, and network interface 312.

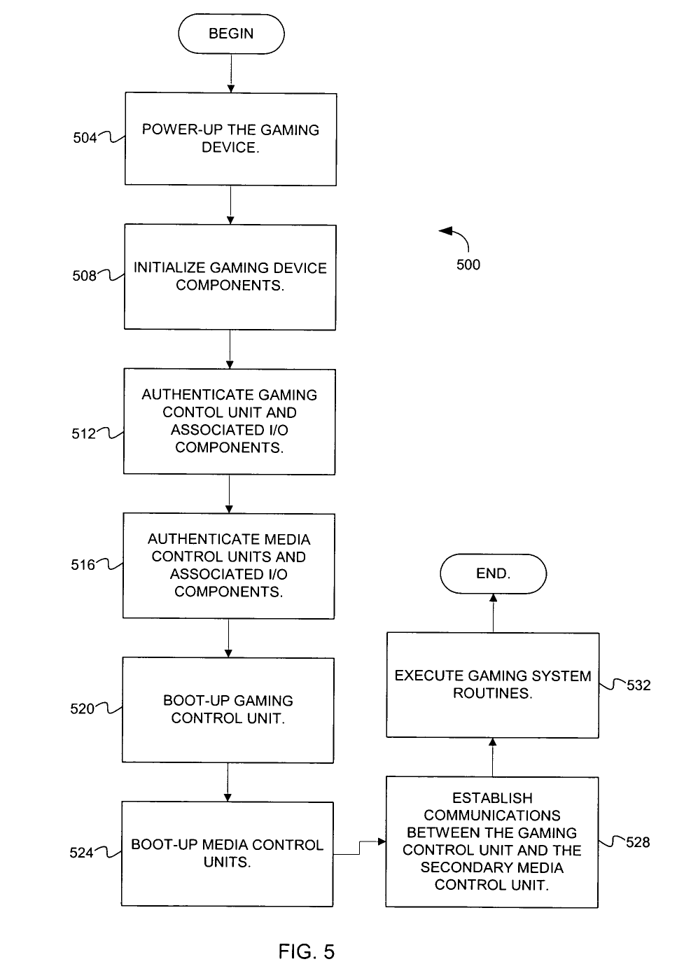

In one embodiment, the authentication unit 318 determines whether the gaming control unit components and data stored therein are secure and trustworthy components. Operations of the authentication unit 318 are described in more detail below, with reference to FIG. 5. In one embodiment, the ram unit 310 can include DRAM, SDRAM, nonvolatile RAM, or any other suitable fast memory. In one embodiment, the network interface 312 provides connectivity with various network types including Eithernet networks, Digital Subscriber Line (DSL) networks, Asynchronous Transfer Mode (ATM) networks, public telephone networks, etc. In one embodiment, the network interface 312 includes circuitry and/or software for transmitting and receiving packets over according to the Transmission Control Protocol and the Internet Protocol (TCP/IP).

The gaming control unit 206 also includes a random number generator 302, mass storage device(s) 304, processor(s) 306, and communication port(s) 308. As shown in FIG. 3, the gaming control unit components are communicatively connected via a bus 320. Some embodiments of the invention include additional components that are not displayed in FIG. 3 (e.g., EEPROMs, ASICs, controllers, etc.). However, alternative embodiments may not include every component shown in FIG. 3. According to embodiments of the invention, the gaming device components (e.g., the authentication unit 318, RAM unit 310, etc.) shown in FIG. 3 can be various processors, application specific integrated circuits (ASICs), memories, and/or machine-readable media for performing operations according to embodiments of the invention. Machine-readable media includes any mechanism that provides (i.e., stores and/or transmits) information in a form readable by a machine (e.g., a computer). For example, a machine-readable medium includes read only memory (ROM), random access memory (RAM), magnetic disk storage media, optical storage media, flash memory devices, electrical, optical, acoustical, or other forms of propagated signals (e.g., carrier waves, infrared signals, digital signals, etc.), etc.

In one embodiment, the mass storage device(s) 304 can be one or more DVD drives, CD-ROM drives, Integrated Drive Electronics/AT Attachment (IDE/ATA) hard disk drives, flash memory storage devices, or any other suitable mass storage device. In one embodiment, the communication port(s) 308 can be universal serial bus (USB) ports, RS-232 ports, parallel ports, fire-wire ports, or any other suitable communication port.

In one embodiment, to comply with gaming regulations, the gaming control unit 206 is contained within a reinforced and hardened casing for security purposes. In one embodiment, the casing can withstand high voltages and extreme conditions (e.g., forces, temperatures, etc.), while allowing the components inside to operate properly.

FIG. 4 is a block diagram illustrating a media control unit including an adapted video game system, according to exemplary embodiments of the invention. According to embodiments of the invention, the media control units 208A and 208N include components of an adapted video game system. For example, in one embodiment, the media control units 208A and 208N include components of a Sony PlayStation 2, available from Sony Computer Entertainment, Inc. of Tokyo, Japan. In an alternative embodiment, the media control units 208A and 208N includes components from a Microsoft Xbox available from Microsoft Corp. of Redmond, Wash. Alternative embodiments call for components from other suitable video game systems (e.g., Nintendo Gamecube, Sega Dreamcast, etc.).

Adapting a video game system to function as a media control unit may require that the video game system be modified in various ways. For example, in order to comply with gaming regulations, certain media control unit components must be capable of being authenticated and withstanding extreme conditions (e.g., high voltages). In one embodiment, software and/or hardware is added to the video game system for authenticating the system's components and data stored therein. In one embodiment, the video game system's original power supply is replaced with a more durable power supply capable of withstanding extreme conditions. Other adaptations may include removing various console parts, such as plastic casings, external wires, external I/O devices, and other components that are unnecessary for presenting media. After the video game system is adapted to present media and conform to regulatory standards, it is communicatively coupled to the gaming control unit 206 to perform the operations described below. In one embodiment, the adapted video game system communicates with the gaming control unit 206 over a serial communications link (e.g., a USB port, RS-232 port, serial bus, etc.). In one embodiment the communications are performed using communication ports 308 and communication ports 434. Alternative embodiments call for other suitable communications links (e.g., parallel port, parallel bus, etc.).

As shown in FIG. 4, according to one embodiment of the invention, each media control unit includes an adapted video game system 400, wherein the adapted video game system is a Sony PlayStation 2. As shown in FIG. 4, the adapted video game system 400 includes a flash memory 402, DVD drive 406, DVD decoder 404, OS read-only memory (ROM) 432, MIPS R3000 CPU 408, geometry transfer engine 410, communication port(s) 434, authentication unit 436, and main RAM 412. The adapted video game system 400 also includes a buffer RAM 414, which is connected to a receiver 416. The adapted video game system 400 also includes a sound processor unit 418, which is connected to a sound RAM 420. The adapted video game system 400 also includes a motion JPEG unit 422, DMA controller 424, graphic processor unit 428, and video RAM 426. As shown in FIG. 4, the graphic processor unit 428 is connected to the video RAM 426. As also shown in FIG. 4, the adapted Sony PlayStation 2 components are connected to a bus 430.

In one embodiment, the adapted video game system 400 includes a media drive (e.g., the DVD drive 406) that has multiple read/write heads. In one embodiment, where the media drive includes multiple heads, the gaming device 100 includes a single media control unit that can simultaneously present media on the primary display unit 104, primary sound unit 202, secondary display unit 106, and secondary sound unit 210. Thus, eliminating the need for multiple media control units.

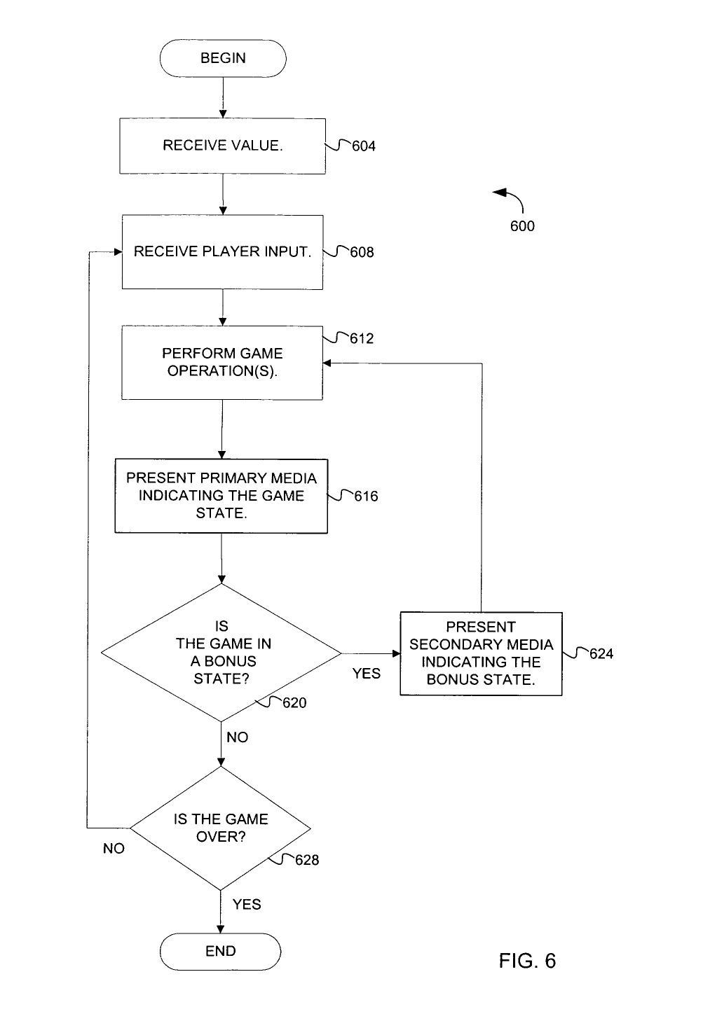

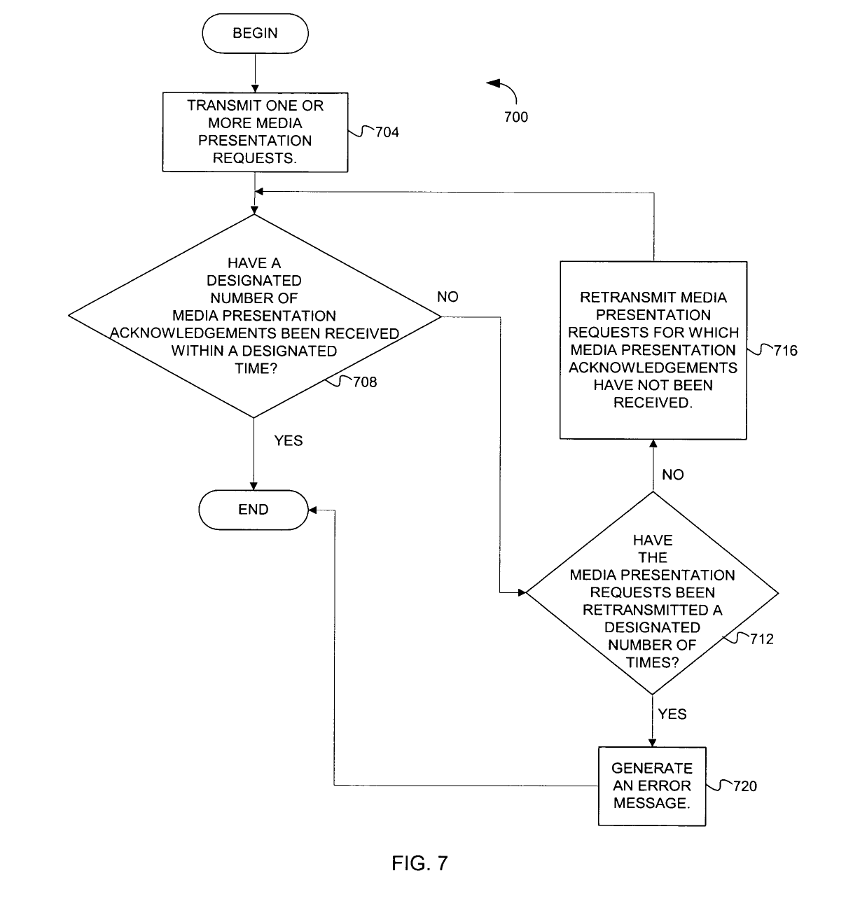

In the discussion above, FIGS. 1-4 describe the general architecture and fundamental constituent components of the gaming device 100. In the discussion below, FIGS. 5-9 describe operations of the various gaming device components. In particular, FIG. 5 describes operations for initializing the gaming device, while FIG. 6 describes operations for presenting media during a game. FIGS. 7-9 describe operations of and communications between the gaming control unit 206 and the media control units 208A and 208N.

FIG. 5 is a flow diagram illustrating operations for initializing a gaming device, according to exemplary embodiments of the invention. The flow diagram 500 will be described with reference to the exemplary embodiments shown in FIGS. 2-4. The flow diagram 500 commences at block 504, where the gaming device 100 is powered-up. For example, a power supply (not shown) receives power from a power source (e.g., a battery, public power utility, etc.) and supplies the power to the gaming device components. The process continues at block 508.

At block 508, gaming device components are initialized. For example, the gaming device components (e.g., processor(s) 306, mass storage device(s) 304, etc.) perform self-initialization operations. In one embodiment, the gaming device components self-initialize by executing hardware/software routines embedded within each component. For example, the processor(s) 306 loads and executes BIOS routines and performs other initialization procedures such as testing the memory cells of the RAM unit 310. The process continues at block 512.

As shown in block 512, the gaming control unit and other I/O components are authenticated. As noted above, many gaming authorities require security measures for ensuring that gaming device components are authentic and trustworthy. Many of the authentication procedures are designed to verify that the gaming device components are unmodified and original. In one embodiment, the authentication unit 318 authenticates components of the gaming control unit 206. For example, in one embodiment, the authentication unit 318 uses public/private key encryption and digital signatures to authenticate the gaming device components. As a more specific example, the authentication unit 318 verifies data stored on the mass storage device(s) by checking digital signatures included within the data. Similarly, the authentication unit authenticates other components and/or data, such as software stored in EEPROMs contained within the random number generator 302. In other embodiments, other suitable authentication techniques can be used (e.g., check sums, challenge-response authentication, etc.). According to one embodiment, the media control units 208A and 208N include redundant authentication devices (not shown) to provide additional security. The process continues at block 516.

At block 516, the media control units and associated I/O components are authenticated. For example, the authentication unit 436 authenticates components of the media control unit 208A. For example, the authentication unit 436 uses public/private key encryption and digital signatures to authenticate the media control unit components. As a more specific example, the authentication unit 436 verifies data stored on the mass storage device(s) by checking digital signatures included within the data. Similarly, the authentication unit 436 authenticates other components and/or data, such as software stored on media contained within the DVD drive 406. In an alternative embodiment, the authentication unit 436 uses challenge-response authentication to verify the authenticity of the media control unit components. According to one embodiment, the media control units 208A and 208N include redundant authentication devices (not shown) to provide additional security. The process continues at block 520.

As shown in block 520, the gaming control unit is booted. For example, the processor(s) 306 loads and executes operating system code, which is stored in the mass storage device(s) 304. In one embodiment, the operating system includes routines for memory management, disk I/O, network communications, port communications, media management, etc. After the gaming control unit 206 has booted, it can communicate with other gaming device components and execute gaming software, as described below. The process continues at block 524.

At block 524, the media control units are booted. For example, the R3000 CPU 408 loads and executes operating system code stored on the OS ROM 432. In one embodiment, the OS ROM's operating system includes routines for memory management, disk I/O, network communications, port communications, media management, etc. After boot-up, the media control units' components can process media requests and perform other tasks, as described in greater detail below. The process continues at block 528.

At block 528, communications are established between the gaming control unit 206 and the media control units. For example, the processor(s) 306 establishes communications with R3000 CPU 408 of the media control unit 208A by exchanging messages over the serial communication link 212. For example, the processor(s) 306 transmits a message to the R3000 CPU 408 via the communication port(s) 308 and serial communications link 212. The R3000 CPU receives the message and transmits a response via the communications port(s) 434 and serial link 212. In one embodiment, if communications cannot be established, the system generates a fault message. The process continues at block 532.

As shown in block 532, gaming device routines are executed. For example, the gaming control unit 206 and media control units 208A and 208N execute gaming device routines. For example, the gaming control unit 206 executes graphics and/or animation routines to inform players that the gaming device is ready to play. As another example, the media control unit 208A executes media routines, which present sound and graphics to potential gaming device players. As another example, the gaming control unit 206 executes routines for playing a game. From block 532, the process ends.

FIG. 6 is a flow diagram illustrating operations for presenting media during a game, according to exemplary embodiments of the invention. The flow diagram 600 will be described with reference to the exemplary gaming device of FIGS. 1-2. The flow diagram 600 commences at block 604, where value is received. For example, the gaming device 100 receives money, gaming credits, gaming tokens, or other value for playing a game. In one embodiment, the value is received in the coin slot 102, bill acceptor 124, credit card reader, or other suitable value-receiving device. The process continues at block 608.

At block 608, player input is received. For example, the gaming device 100 receives various player inputs including bets, reel spins, and cash-outs. In one embodiment, players provide input by pressing the gaming device buttons 110, 114, and 116. The process continues at block 612.

At block 612, game operation(s) are performed. For example, the gaming control unit 206 performs game operations. In one embodiment, the gaming control unit 206 performs the game operations in response to player input. In one embodiment, game operations include spinning the slot machine reels, processing bets, etc. The game operations also includes tracking the game state. In one embodiment, the game state includes the reels positions at any given time, bet amounts, bonus state information, game results, and other information used for tracking and processing the progress and results of the game. The process continues at block 616.

At block 616, primary media indicating the game state is presented. For example, the media control unit 208N presents primary media, which represents the game state, on the primary display unit 104 and/or the primary sound unit 202. In one embodiment, the primary media for representing the game state includes various two and three-dimensional graphical images in the form of digitized video, animation, sprites, and other suitable visual representations of the game's progress and outcome. In one embodiment, the primary media indicating the game state is a three-dimensional graphical representation of the slot machine's reels in spinning and stationary states. The process continues at block 620.

At block 620, it is determined whether the game is in a bonus state. For example, the gaming control unit 206 determines whether the game is in a bonus state. In one embodiment, a slot machine game is in a bonus state after the reels stop on a particular symbol combination. In an alternative embodiment, the game is in a bonus state after a player wins a predetermined cash amount. According to alternative embodiments, the game is in a bonus state when other predetermined events occur. If the game is in a bonus state, the process continues at block 624. Otherwise, the process continues at block 628.

At block 624, secondary media, which indicates that the game is in a bonus state, is presented. For example, the gaming control unit 206 requests that the media control unit 208A presents secondary media indicating a bonus state. In turn, the media control unit 208A presents the secondary media on the secondary display unit 106 and/or the secondary sound unit 210. In one embodiment, the secondary media content for indicating that the game is in a bonus state includes animation, digital video, and other graphical representations. Additionally, secondary media content includes music, dialogue, and other suitable audio content. In one embodiment, when the game is in a bonus state, the media system 200 presents text messages, animated cartoons, and music for entertaining players and onlookers. The process continues at block 612.

As shown in block 628, it is determined whether the game is over. For example, the gaming control unit 206 determines whether the game is over based on the game state. For example, the gaming control unit 206 determines whether a slot machine game is over if the reels have made a transition from a spinning to a stationary state. If the game is over, the process ends. Otherwise, the process continues at block 608.

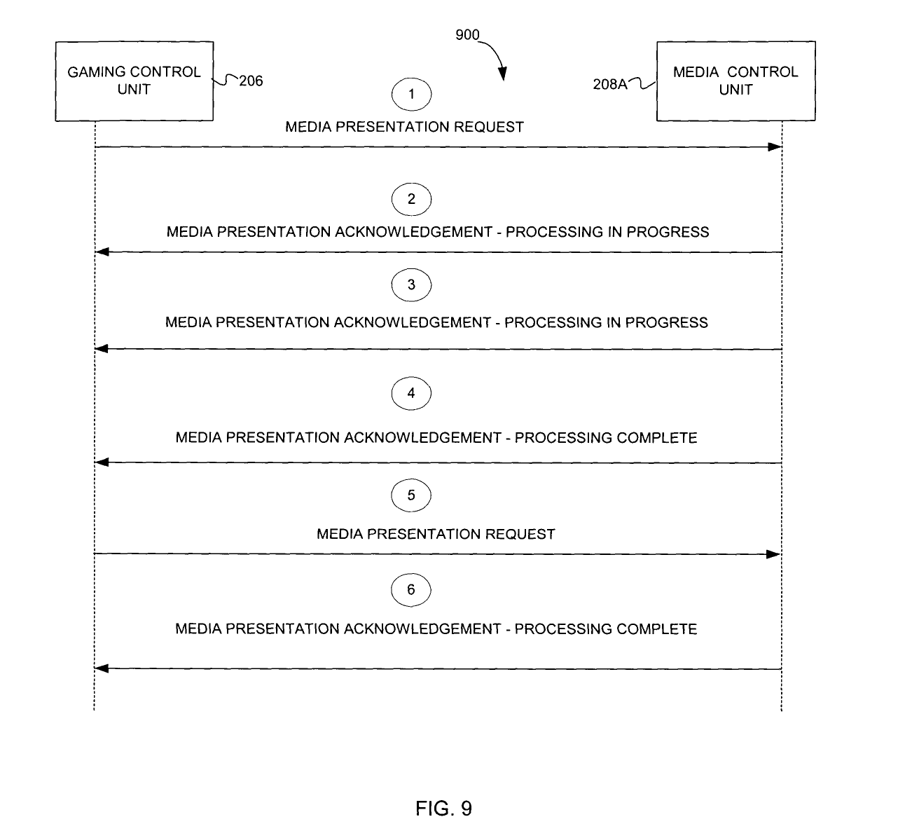

In the following discussion of FIGS. 7-9, operations for exchanging media presentation requests and acknowledgements are described. In FIG. 9, communications between the gaming control unit 206 and the media control unit 208 are described.

FIG. 7 is a flow diagram illustrating operations for requesting the presentation of media, according to exemplary embodiments of the invention. The flow diagram 700 will be described with reference to the exemplary embodiment of FIG. 2. The flow diagram 700 commences at block 704.

At block 704, one or more media presentation requests are transmitted. For example, the gaming control unit 206 transmits one or more media presentation requests to the media control unit 208A. In one embodiment, media presentation requests are data packets including a request indicator, one or more media indicators, and one or more synchronization indicators. The request indicator is a data field that indicates the packet is a secondary media request containing media request information. The media indicators are data fields indicating specific media content that is to be presented. For example, the media indicators can include physical addresses at which specific secondary media content is stored (e.g., RAM addresses, hard disk addresses, CD-ROM addresses, DVD addresses, etc.). In one embodiment, media indicators include beginning and ending disk addresses where secondary media content is stored. The process continues at block 708.

At block 708, it is determined whether a designated number of media presentation acknowledgments have been received within a designated time. For example, the gaming control unit 206 determines whether it has received a designated number of media presentation acknowledgments from the media control unit 208A, within a given time. As a more specific example, the gaming control unit 206 determines whether it received a media presentation acknowledgment for each media presentation request sent to the media control unit 208A. Additionally, the gaming control unit 206 determines whether those requests were received within a designated time. If the designated number of media presentation acknowledgments has been received, the process ends. Otherwise, the process continues at block 712.

As shown in block 712, it is determined whether the media presentation requests have been retransmitted a designated number of times. For example, the gaming control unit 206 determines whether it has retransmitted the media presentation requests a designated number of times (e.g., 10 times). If the gaming control unit 206 has retransmitted the media presentation requests a designated number of times, the process continues at block 720. Otherwise, the process continues at block 716.

At block 716, media presentation requests are retransmitted for each of the media presentation acknowledgments that have not been received. For example, the gaming control unit 206 retransmits media presentation requests for each media presentation acknowledgment that it has not received. From block 716, the process continues at block 708.

At block 708, an error message is generated. For example, the gaming control unit 206 generates and error message indicating that the media control unit 208A is not responding to communications. From block 720, the process ends. Although the examples discussed above describe the media control unit 208A performing the operations of the flow diagram 700, the media control unit 208N can also perform the operations of flow diagram 700.

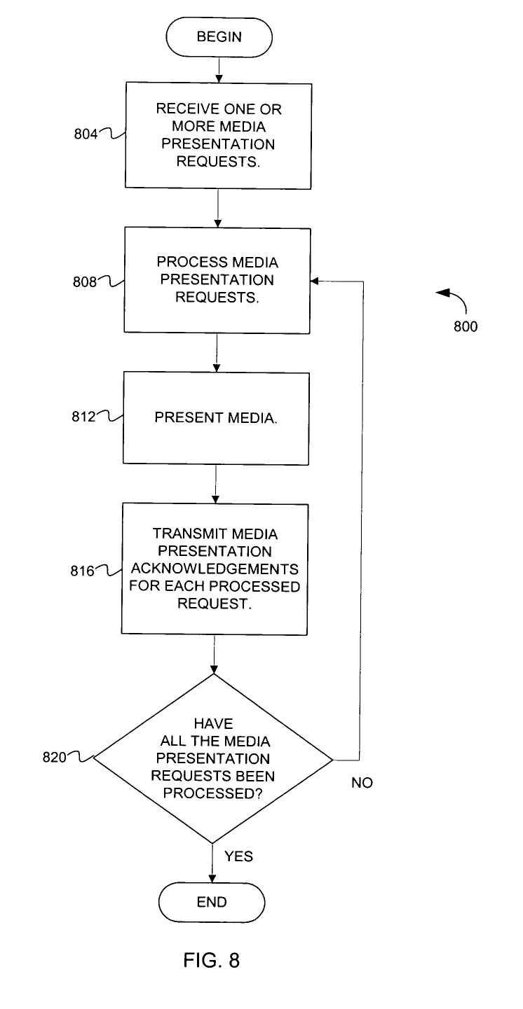

FIG. 8 is a flow diagram illustrating operations for receiving and processing media presentation requests, according to exemplary embodiments of the invention. Flow diagram 800 will be described with reference to the exemplary embodiments of FIGS. 2-4. The flow diagram 800 commences at block 804.

At block 804, one or more media presentation requests are received. For example, the media control unit 208A receives one or more media presentation requests from the gaming control unit 206 over the serial connection 212. In one embodiment, the secondary media control unit's R3000 CPU receives the media presentation requests through the communication ports 434. The process continues at block 808.

As shown in block 808, the media presentation requests are processed. For example, the R3000 CPU 408 processes the media presentation requests. In one embodiment, the R3000 CPU 408 extracts one or more media indicators and one or more synchronization indicators from the media presentation request. The process continues at block 812.

At block 812, media is presented. For example, the media control unit 208A presents the media. In one embodiment, the R3000 CPU 408 fetches media content from the DVD drive 406 at disk addresses designated in the media indicators. The media content is then processed by various media control unit components depending on its media type. For example, digital video content stored in the JPEG format is decoded and process by the motion JPEG unit 422. As another example, the geometry transfer engine 410 processes animation video content. As yet another example, the sound processor unit 418 processes sound content. After processing the secondary media content, the media control unit 208A presents the media content on the secondary sound unit 210 and/or the secondary display unit 106. From block 812, the process continues at block 816.

At block 816, media presentation acknowledgments are transmitted for each processed request. For example, the secondary media control unit transmits media presentation acknowledgments for each media presentation requests that it has processed. In one embodiment the media control unit 208A transmits multiple media presentation acknowledgments for each media presentation request. In one embodiment, the media presentation acknowledgments are data packets including an acknowledgment indicator, a synchronization indicator, and a progress indicator. The acknowledgment indicator is a data field that distinguishes the data packet as a media presentation acknowledgment. The synchronization indicator indicates the time at which the media control unit 208A presented a particular sample of secondary media. In one embodiment, the R3000 CPU 408 transmits the media presentation acknowledgments to the gaming control unit 206 over the serial communication connection 212. From block 816, the process continues at block 820.

At block 820, it is determined whether all the media presentation requests have been processed. For example, the R3000 CPU 408 determines whether all the media presentation requests have been processed. If all the media presentation requests have been processed, the flow ends. Otherwise, the flow continues at block 808. Although the examples discussed above describe the media control unit 208A performing the operations of the flow diagram 800, the media control unit 208N can also perform the operations of flow diagram 800.

FIG. 9 is a block diagram illustrating communications between a media control unit and a gaming control unit, according to exemplary embodiments of the invention. The block diagram 900 illustrates six messages exchanged between the gaming control unit 206 and the media control unit 208A. It should be understood that the same communications can be transmitted between the gaming control unit 206 and the media control unit 208N. As shown in FIG. 9, the messages are illustrated as directed edges (i.e., arrows) running from the gaming control unit 206 to the media control unit 208A. As also shown in FIG. 9, the messages are transmitted during six communication stages, which are illustrated by circled numerals.

At stage 1, the gaming control unit 206 transmits a media presentation request to the media control unit 208A. At stages 2 and 3, the media control unit 208A transmits media presentation acknowledgments, to the gaming control unit 206. As shown in FIG. 9, the media presentation acknowledgments of stages 2 and 3 indicate that processing is in progress. As noted above, in one embodiment, the media control unit 208A transmits multiple media presentation acknowledgments for each received media presentation request. In one embodiment, the gaming control unit 206 uses the synchronization information contained within each media presentation acknowledgment to determine when specific media content was presented by the media system 200.

At stage 4, the media control unit 208 transmits another media presentation acknowledgment, which indicates that processing is complete. At stage 5, the gaming control unit 206 transmits a media presentation request to the media control unit 208. At stage six, the secondary media control unit transmits a media presentation acknowledgment, which indicates that processing is complete, to the gaming control unit 206. Although only six communication stages are shown in FIG. 9, in one embodiment, the gaming control unit 206 and the media control unit 208 continuously exchange media presentation requests and acknowledgments when the gaming device 100 is operational.

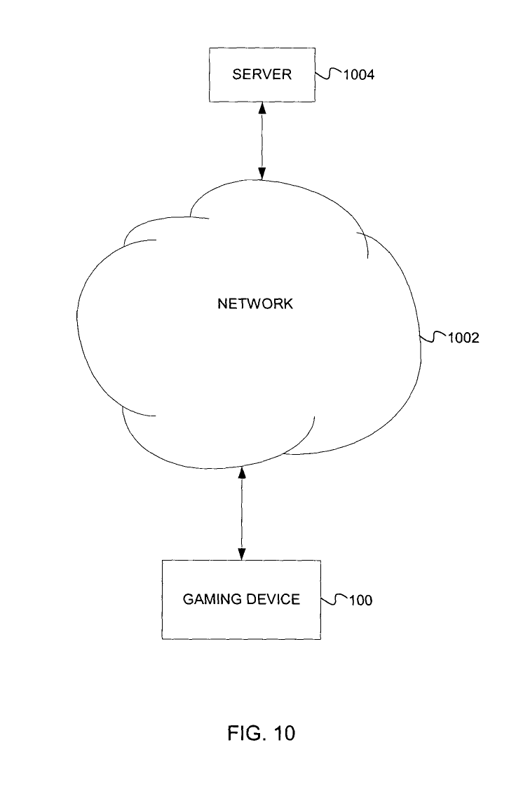

FIG. 10 is a block diagram illustrating a gaming device configured to operate in a network environment, according to embodiments of the invention. As shown and FIG. 10, a gaming device 100 is connected to a network 1002. The network 1002 is connected to a server 1004. In one embodiment, the network 1002 can be a private wide area network, local area network, or global network such as the Internet and/or the World Wide Web. Moreover, the network 1002 can include various physical layer technologies, such as Ethernet, Sonnet, Asynchronous Transfer Mode, etc. For example, the gaming device 100 and server 1002 can communicate over public telephone lines, ISDN lines, fiber-optic lines, wireless network links and/or other communication channels using any suitable protocols.

In one embodiment, the server 1004 includes a processor that is capable of determining the outcome of a game being played on the gaming device 100. In one embodiment, the gaming device 100 receives and processes player input. The gaming device transmits to the server 1004 one or more data packets indicating the player input. In response to receiving the data packets, the server 1004 determines a result of the game. After determining the game result, the server 1004 transmits the game result to the gaming device 100. In one embodiment, the gaming device 100 presents media based on the gaming result.

While the invention has been described in terms of several embodiments, those skilled in the art will recognize that the invention is not limited to the embodiments described. The method and apparatus of the invention can be practiced with modification and alteration within the spirit and scope of the appended claims. The description is thus to be regarded as illustrative instead of limiting on the invention.

1. A method comprising:
receiving player input in a gaming control unit;
performing a set of one or more game operations, wherein certain ones of the set determine an outcome of a game;
presenting primary media indicating a game state;
determining whether the game state is a bonus state;
if the game state is a bonus state, presenting secondary media, wherein the primary media and secondary media are presented on a media system, the media system including,
a set of one or more media control units, wherein each media control unit includes an adapted video game system.

2. The method of claim 1, wherein the adapted video game system is adapted from a Sony PlayStation 2.

3. The method of claim 1, where the game is a slot machine game.

4. The method of claim 1, wherein the adapted video game system is adapted from a Microsoft Xbox.

5. A method comprising:
transmitting a first set of one or more media presentation requests to a media control unit, wherein the media control unit is included within a gaming device, and wherein the media control unit includes an adapted video game system; and
receiving, in a gaming control unit, a second set of one or more media presentation acknowledgements from the media control unit, wherein the media presentation acknowledgements indicate that the media control unit has presented certain media samples.

6. The method of claim 5 further comprising:
determining whether a designated number of media presentation acknowledgements have been received; and
if the number of media presentation acknowledgements has not been received, retransmitting ones of the first set.

7. The method of claim 5, wherein the adapted video game system is a Sony PlayStation 2.

8. The method of claim 5, wherein the gaming device is a slot machine.

9. The method of claim 5, wherein the adapted video game system is a Microsoft Xbox.

10. A method comprising:
receiving, in a media control unit of a gaming device, a first set of one or more media presentation requests, wherein the media control unit includes an adapted video game system;
presenting media on a display unit or a sound unit; and
transmitting media presentation acknowledgements to a gaming control unit.

11. The method of claim 10, wherein each of the media presentation requests indicates a media sample, and wherein the media sample is stored within the adapted video game system.

12. The method of claim 10, wherein the gaming device is a slot machine.

13. The method of claim 10, wherein the adapted video game system is adapted from a Sony PlayStation 2.

14. The method of claim 10, wherein the adapted video game system is adapted from a Microsoft Xbox.

15. A gaming device comprising:
a gaming control unit, the gaming control unit to transmit media presentation requests;
a media control unit to receive the media presentation requests from the gaming control unit and present media, the media control unit including an adapted video game system;
a display unit communicatively coupled to the media control unit to display video; and
a secondary sound unit communicatively coupled to the media control unit to present secondary audio.

16. The gaming device of claim 15, wherein secondary media is presented when a game executing on the game control unit is in a bonus state.

17. The gaming device of claim 15, wherein the adapted video game system is an adapted Sony PlayStation 2.

18. The gaming device of claim 15, wherein the gaming device is a slot machine.

19. The gaming device of claim 15, wherein the adapted video game system is an adapted Microsoft Xbox.

20. A gaming device comprising:
a gaming control unit to transmit media presentation requests; and
a set of one or more media control units to receive the media presentation requests from the gaming control unit and present primary media and secondary media, wherein the secondary media is presented when the a game is in a bonus state, and wherein each media control unit of the set includes an adapted Sony PlayStation 2.

21. The gaming device of claim 20, wherein secondary media includes video animation.

22. The gaming device of claim 20, wherein the gaming device is a slot machine.

23. The gaming device of claim 20, wherein the adapted video game system is adapted from a Microsoft Xbox.

24. A machine-readable medium that provides instructions, which when executed by a machine, cause the machine to perform operations comprising:
receiving player input in a gaming control unit;
performing a set of one or more game operations, wherein certain ones of the set determine an outcome of a game;
presenting primary media indicating a game state;
determining whether the game state is a bonus state;
if the game state is a bonus state, presenting secondary media, wherein the primary media and secondary media are presented on a media system, the media system including,
a set of one or moremedia control units, wherein eachmedia control unit includes an adapted video game system.

25. The machine-readable medium of claim 24, wherein the adapted video game system is adapted from a Sony PlayStation 2.

26. The method of claim 24, where the game is a slot machine game.

27. The machine-readable medium of claim 24, wherein the adapted video game system is adapted from a Microsoft Xbox.

28. A machine-readable medium that provides instructions, which when executed by a machine, cause the machine to perform operations comprising:
transmitting a first set of one or more media presentation requests to a media control unit, wherein the media control unit is included within a gaming device, and wherein the media control unit includes an adapted video game system; and
receiving, in a gaming control unit, a second set of one or more media presentation acknowledgements from the media control unit, wherein the media presentation acknowledgements indicate that the media control unit has presented certain media samples.

29. The machine-readable medium of claim 28 further comprising:
determining whether a designated number of media presentation acknowledgements have been received; and
if the number of media presentation acknowledgements has not been received, retransmitting ones of the first set.

30. The machine-readable medium of claim 28, wherein the adapted video game system is a Sony PlayStation 2.

31. The machine-readable medium of claim 28, wherein the gaming device is a slot machine.

32. The machine-readable medium of claim 28, wherein the adapted video game system is a Microsoft Xbox.

33. A machine-readable medium that provides instructions, which when executed by a machine, cause the machine to perform operations comprising:
receiving, in a media control unit of a gaming device, a first set of one or more media presentation requests, wherein the media control unit includes an adapted video game system;
presenting media on a display unit or a sound unit; and
transmitting media presentation acknowledgements to a gaming control unit.

34. The machine-readable medium of claim 33, wherein each of the media presentation requests indicates a media sample, and wherein the media sample is stored within the adapted video game system.

35. The machine-readable medium of claim 33, wherein the gaming device is a slot machine.

36. The machine-readable medium of claim 33, wherein the adapted video game system is adapted from a Sony PlayStation 2.

37. The machine-readable medium of claim 33, wherein the adapted video game system is adapted from a Microsoft Xbox.
